(19) United States
(12) Patent Application Publication
(10) Pub. No.: US 2006/0086827 A1
(43) Pub. Date: Apr. 27, 2006

(54) Liquid spray unit, method for spraying liquid using it, and chemical

(76) Inventor: Hiroshi Sekiya, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/522,648

(22) PCT Filed: Sep. 12, 2002
(86) PCT No.: PCT/JP02/09371

§ 371 Date: Sep. 12, 2005

(30) Foreign Application Priority Data
Jul. 31, 2002 (JP) 2002-224234

(51) Int. Cl. B05B 7/04

(52) U.S. Cl. 239/433; 239/290

(57) ABSTRACT

A liquid spray unit which can impart liquid (treating liquid, medicine, or the like) surely to a traveling body even in a high speed paper making machine. The liquid spray unit for spraying liquid to a traveling body comprises a spray tube provided with a nozzle for spraying liquid, and an air box provided with an opening for jetting an air flow, wherein the spray tube and the air box are arranged such that the air flow is jetted from the air jet opening toward the liquid sprayed from the spray nozzle and the sprayed liquid can be blown to the traveling body after being accelerated by the air flow. The liquid can be sprayed more effectively to the traveling body by making compact the unit depending on the quantity of liquid being imparted or the inner space of a paper making machine, or the like, or by employing a unit of a type of reciprocating a single nozzle.

### TECHNICAL FIELD

### Technical Field Pertinent to the Invention

The present invention relates to a liquid spray unit applied to an object traveling at high speed, and more particularly, to a liquid spray application unit for securely applying liquid to paper moving at high speed by a paper making machine or the like, kinds of rolls such as a drier roll, a press roll and the like in the paper making machine or the like, and members such as a canvas, wire or the like.

### BACKGROUND ART

### Prior Art

In conventional, in order to increase paper strength, make multi-layer paperboard and the like, liquid such as paper strength increasing agent, interlayer adhesive agent or the like is applied to the paper moving inside the paper making machine.

Further, for the purpose of preventing foreign materials caused by pulp raw materials from being transferred from the paper and improving on paper release, the chemical such as antipollution agent, mold releasing agent or the like is applied to the member such as the wire, the felt, the drier roll, the canvas or the like of the paper making machine.

In recent years, in particular, recycling of used paper or the like becomes popular, necessity of spraying the paper strength increasing agent or the like has been increased.

Further, the higher compounding ratio of the used paper is, the more the foreign material such as gum pitch of hot melt system, or carbon-vinyl acetate system caused by the used paper pulp (DIP) and the like brought in raw material is increased. Accordingly, soils to the members such as the wire, the felt, the drier roll, the canvas and the like increase, as a result, it's caused product defects and low runability.

Therefore, it is indispensable to apply a cleaning agent, pitch control agent, the antipollution agent, the mold releasing agent and the like to the members.

The various kinds of liquid mentioned above is generally sprayed and applied from the nozzle in a state in which the paper making machine is operated, that is, to the rolls such as the rotatable drier roll or the like, the canvas, the wire or the like which circulate inside the paper making machine, or the paper which is conveyed by these members and moves inside the paper making machine (in this present specification, the rotating, circulating or moving paper and members are generically called as a traveling body).

However, since an air flow (hereinafter, refer to as a surface current) is generated along the movement near a surface of the traveling body moving at high speed, there is generated a phenomenon that the liquid sprayed to the traveling body is rolled up to a downstream side.

An applying amount of the liquid to the paper or the like is reduced at an amount that the liquid is rolled up on the basis of the phenomenon mentioned above, and the yield ratio is deteriorated.

Further, the rolled-up liquid is attached to a frame, a hood or the like so as to contaminate the paper making machine, and is condensed on a surface of the hood or the like so as to come down on the paper, thereby generating a trouble such as to lower quality of paper products.

As a unit for preventing the liquid from being rolled up, the inventor of the present invention has already proposed a fluid spraying fluid sprash preventing unit (refer to Japanese Unexamined Utility Model Publication No. 1-152762) in which an air curtain is formed in an upstream side and a downstream side of a spraying nozzle of the liquid (fluid), and the liquid is sprayed in space therebetween (refer to FIG. 10).

This unit 100 intends to obtain stable spraying of liquid 101 applied to a traveling body 105 by shielding a surface current near a surface of the traveling body 105 (in this case, the forward moving direction is the direction shown by an arrow 104) by means of two front and rear air curtains 103 of an injection nozzle 102.

In accordance with the unit mentioned above, in the conventional paper making machine in which paper making speed is comparatively low, the most liquid 101 reaches the traveling body 105, and it is possible to solve the problem mentioned above.

However, the paper making speed of the paper making machine is recently very high, and there appears a paper making machine having paper making speed of 1500 m/min or 2000 m/min.

In the paper making machine having very high speed, the surface current in the periphery of the traveling body 105 such as the paper, the drier roll, the canvas and the like becomes extremely strong in accordance with wind speed and wind pressure.

Under the extremely strong wind speed and wind pressure of the surface current as mentioned above, the surface current can not be necessarily sufficiently shielded by the air curtain of the unit mentioned above.

Accordingly, the surface current in the periphery of the traveling body is rather disturbed largely by the air curtain so as to generate air turbulence.

When the liquid is sprayed in the state mentioned above, there is a case that a problem that the liquid is rather rolled up violently to the downstream side is generated.

As mentioned above, because of appearance of the paper making machine having very high speed, in the unit employing the technique of shielding the surface current as mentioned above, it becomes hard to achieve the stable spraying of the liquid to the traveling body.

However, for the meantime, in view of recycle or the like, there is a tendency that a compounding ratio of the used paper or the like with respect to the paper raw material is increased for the future.

Accordingly, a more severe request is applied to intension of the paper strength, prevention of foreign materials from being transferred to the member (contamination prevention), improvement of a paper release from the member, and the like, and a chance of applying the liquid to the paper or the member of the paper making machine is increased.

Accordingly, even in the paper making machine having very high speed as mentioned above, there is required a spray unit which can securely apply the liquid to the traveling body such as the paper, the member or the like.

### Problem to be Solved by the Invention

The present invention is made for the purpose of solving the problem mentioned above, on the basis of the background mentioned above.

In other words, an object of the present invention is to provide a liquid spray unit which can securely apply liquid (processing solution, medical agent or the like) to a traveling body even in a paper making machine having very high speed.

### DISCLOSURE OF THE INVENTION

### Means for Solving the Problem

Accordingly, as a result of devoting themselves to carry on a study on the purpose and background mentioned above, the inventors of the present invention have found a matter that it is possible to apply the liquid securely and in a state in which a roll-up to a downstream side is inhibited even in a surface current having great wind speed and wind pressure, by spraying the liquid which is once sprayed from a spray nozzle to the traveling body after being got on a high speed air flow injected from the other air flow injection port, and have completed the present invention on the basis of the knowledge.

In other words, in accordance with the present invention, there is provided (1) a liquid spray unit for spraying and applying liquid to a traveling body, comprising:

a spray nozzle for spraying the liquid; and

an air flow injecting port for injecting an air flow,

wherein the spray nozzle and the air flow injecting port are arranged such as to inject the air flow to the liquid sprayed from the spray nozzle, from the air injecting port, and accelerate the sprayed liquid by the air flow so as to spray to the traveling body.

Further, there is provided (2) a liquid spray unit for spraying and applying liquid to a traveling body, comprising:

a spray tube provided with a spray nozzle for spraying the liquid; and

an air box provided with an air flow injecting port for injecting an air flow,

wherein the spray tube and the air box are arranged such as to inject the air flow to the liquid sprayed from the spray nozzle, from the air injecting port, and accelerate the sprayed liquid by the air flow so as to spray to the traveling body.

Further, there is provided (3) a liquid spray unit, wherein the air box is provided with an outer wall and an air pipe mounted inside the outer wall via a support piece.

Further, there is provided (4) a liquid spray unit, wherein the air pipe is structured such that a plurality of through holes are formed at opposite positions to the air flow injecting port provided in the outer wall in the tube wall.

Further, there is provided (5) a liquid spray unit, wherein the spray tube is provided with a plurality of spray nozzles which are arranged in parallel at a fixed interval in a width direction of the traveling body.

Further, there is provided (6) a liquid spray unit, wherein the spray tube is provided with a liquid feeding tube for feeding the liquid to the spray nozzle, an air feeding tube for feeding compressed air, and a pressure regulating tube for uniformizing pressure of the compressed air inside the air feeding tube.

Further, there is provided (7) a liquid spray unit, wherein the spray tube is provided with a pressure regulating tube for uniformizing pressure of the liquid inside the liquid feeding tube.

Further, there is provided (8) a liquid spray unit, wherein the spray tube is fixed to the air box at an interval.

Further, there is provided (9) a liquid spray unit, wherein the spray nozzle has a flat spray pattern and is fixed to the spray tube in a state of being inclined with each other.

Further, there is provided (10) a liquid spray unit, wherein the spray tube is fixed by being fitted to the air box.

Further, there is provided (11) a liquid spray unit, wherein the spray tube is provided with one spray nozzle, and sprays and applies the liquid while reciprocating in a width direction of the traveling body.

Further, there is provided (12) a liquid spray unit, wherein the traveling body is constituted by the paper moving in a paper making machine or a processing machine.

Further, there is provided (13) a liquid spray unit, wherein the traveling body is constituted by a member rotating or circulating inside a paper making machine or a processing machine.

Further, there is provided (14) a liquid spray method of spraying and applying a liquid to a traveling body by using the liquid spray unit as recited in the item (1) mentioned above.

Further, there is provided (15) a chemical used for the liquid spray method as recited in the item (14) mentioned above.

Further, there is provided (16) a chemical, wherein the chemical is constituted by a combination of one or two of an antipollution agent, a dusting preventing agent, a pitch control agent, a mold releasing agent, an adhesive agent, a surface correcting agent, a cleaning agent, a paper strength intensifying agent, a size agent, a yield improving agent, a water repellent agent, an oil repellent agent, a slide preventing agent, a lubricant, a softening agent and a moistening agent.

The present invention can, of course, employ structure obtained by combining two or more of the items (1) to (16) mentioned above, as far as the object of the present invention can be achieved.

### Effect of the Invention

In accordance with the present invention, it is possible to securely apply the liquid to the traveling body even if the speed of the paper making machine or the like becomes very high, by injecting the air flow from the air flow injecting port to the liquid sprayed from the spray nozzle, and accelerating the liquid so as to spray to the traveling body.

Further, it is possible to more effectively spray the liquid to the traveling body, by making the unit compact in correspondence to an amount of application of the liquid and space in an inner portion of the paper making machine or the like, and setting the structure to a type of reciprocating a single nozzle.

### BRIEF DESCRIPTION OF THE DRAWINGS

FIGS. 1(A) and 1(B) are views showing an example of structure in a width direction of a traveling body, in which FIG. 1(A) is a bottom elevational view and FIG. 1(B) is a cross sectional view along a line X-X;

FIG. 2 is a schematic view showing a state in which a liquid spray unit A1 inhibits mist from soaring;

FIGS. 3(A) and 3(B) are schematic views explaining a fixed state of a spray tube and an air box, in which FIG. 3(A) shows a state in which they are closely fixed, and FIG. 3(B) shows a state in which they are fixed at an interval;

FIG. 4 is a view showing a method of spraying and applying liquid to the paper by using the liquid spray unit A1;

FIG. 5 is a schematic view showing a state in which the liquid is sprayed in a state of being inclined with respect to the spray tube;

FIG. 6 is a cross sectional perspective view showing a liquid spray unit A2 having more compact structure;

FIG. 7 is a schematic view showing a state in which liquid and an air flow are injected from a liquid spray unit A2;

FIG. 8 is a perspective view showing a liquid spray unit A3 which is suitable for low volume spray;

FIGS. 9(A) and 9(B) are enlarged views of a head portion of the liquid spray unit A3, in which FIG. 9A is a perspective view of the entire head portion, and FIG. 9(B) is a cross sectional view along a line Y-Y of an air box 2; and

FIG. 10 is a schematic view explaining a conventional fluid sprash preventing unit for spraying the fluid.

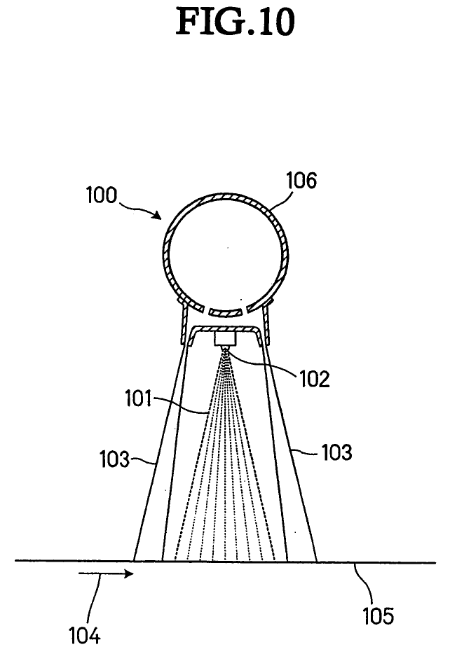

### BEST MODE FOR CARRYING OUT THE INVENTION

### Embodiments of the Invention

A description will be given below of a liquid spray unit in accordance with the present invention by listing up some preferable embodiments, with reference to the accompanying drawings.

The liquid spray unit in accordance with the present invention is mainly provided with a spray nozzle for spraying liquid, and an air flow injecting port injecting an air flow for accelerating the sprayed liquid.

Further, the liquid is securely applied to a traveling body, by injecting the air flow from the other air flow injecting port to the liquid sprayed from the spray nozzle, and accelerating the sprayed liquid on the air flow so as to spray to the traveling body.

### First Embodiment

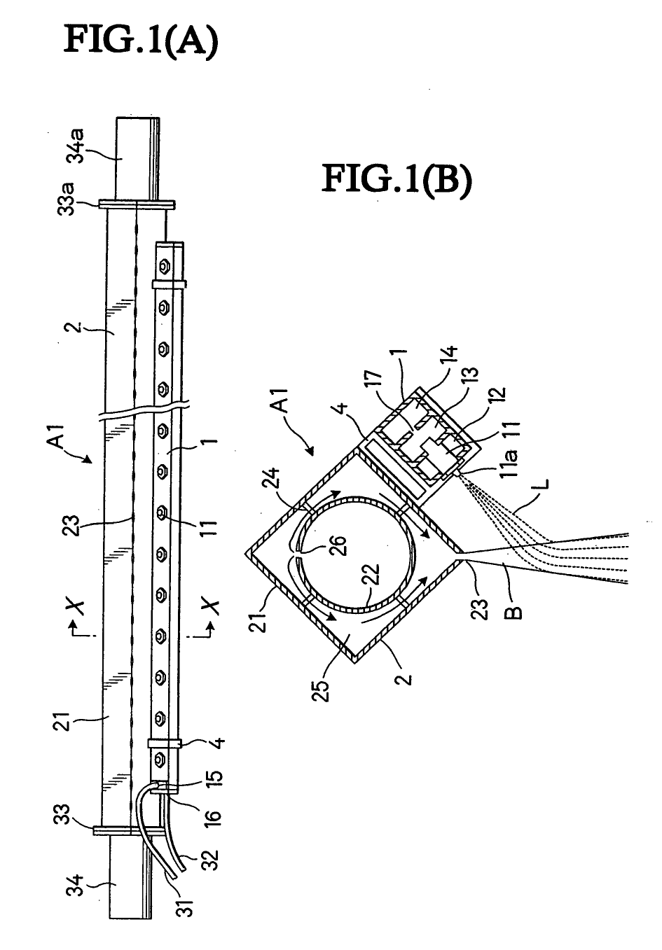

FIGS. 1A and 1B are views showing an example of structure of a liquid spray unit provided with plurality of spray nozzles in a width direction of a traveling body, in which FIG. 1A is a bottom elevational view and FIG. 1B is a cross sectional view along a line X-X.

A liquid spray unit A1 of this type is provided with a spray tube 1 and an air box 2.

The spray tube 1 is provided with plurality of spray nozzles 11 which are arranged in parallel at a fixed interval.

In the present structural example, since a binary fluid nozzle is used as the spray nozzle 11, the spray tube 1 is provided with a liquid feeding pipe 12 for feeding the liquid to each of the spray nozzles 11, an air feeding tube 13 for feeding compressed air, and a pressure regulating tube 14 for uniformizing pressure of the compressed air inside the air feeding tube.

In the present structural example, the spray tube 1 is integrally formed such that the liquid feeding tube 12, the air feeding tube 13 and the pressure regulating tube 14 which are formed in a flat rectangular cross sectional shape are overlapped and welded.

The liquid feeding tube 12 and the air feeding tube 13 are respectively communicated with a liquid supply tube 31 and an air supply tube 32 by a liquid injection port 15 and an air injection port 16 which are formed at one terminal end of the spray tube 1, and are supplied the liquid and the air from a chemical tank and a compressor or the like (not shown) in an external portion.

The injection nozzle 11 is screwed with the spray tube 1 in such a manner that an intake port in a bottom portion thereof is open to the air feeding tube 13, and a liquid suction port in a side surface thereof is open to the liquid feeding tube 12, respectively.

When spraying the liquid L from plurality of spray nozzles 11 all at once under the state mentioned above, the pressure of the compressed air inside the air feeding tube 13 generates a pressure gradient in a direction of entire length of the spray tube 1.

In other words, so-called pressure loss is generated in a terminal end side in a direction of entire length of the air feeding tube 13 (an opposite end side to the air injection port 16), and a spray amount of the liquid L is lowered.

In order to avoid the disadvantage mentioned above, in the spray tube 1 in accordance with the present structural example, some holes 17 are provided in a penetrating manner at some positions on a partition wall between the air feeding tube 13 and the pressure regulating tube 14.

Autonomous pressure regulation is executed such that the air is communicated between the air feeding tube 13 and the pressure regulating tube 14 via the holes 17 and the pressure of the compressed air inside the air feeding tube 13 becomes as uniform as possible in the direction of the entire length, that is, the spray amount of the liquid L becomes approximately constant in all the spray nozzles 11.

As mentioned above, the pressure regulating tube 14 is provided so as to uniformize the pressure of the compressed air in the air feeding tube 13.

Accordingly, the spray tube 1 may be mounted to the side surfaces of the liquid feeding tube 12 and the air feeding tube 13 which are overlapped.

Further, in the case that it is necessary to uniformize the pressure of the liquid inside the liquid feeding tube 12, for example, it is preferable to attach a pressure regulating tube for the liquid feeding tube to an opposite side surface to the pressure regulating tube for the air feeding tube attached to the side surfaces of the liquid feeding tube 12 and the air feeding tube 13 mentioned above.

The air box 2 is provided with an outer wall 21, and an air pipe 22 for feeding a compressed air for an injection air flow to an inner portion.

The outer wall 21 is constituted by a tubular structure body having a rectangular cross sectional shape in the present structural example, and plurality of holes are passed through one ridge line so as to form an air flow injection port 23.

The air pipe 22 is attached to an inner portion of the outer wall 21 via a plurality of support pieces 24, and space 25 is continuously formed between the outer wall 21 and the air pipe 22.

Plurality of penetrating holes 26 are formed at an opposite position to the air flow injection port 23 in a tube wall of the air pipe 22.

A mounting pipe 34 is attached to the air box 2 via a flange 33, and a mounting pipe 34 doubling as an air supply tube and the air pipe 22 of the air box 2 are connected on the basis of the attachment.

A compressed air is fed to the air pipe 22 from a blower or the like (not shown) in an external portion via the mounting pipe 34 (the air supply tube).

When the compressed air is injected to the air pipe 22 of the air box 2 formed in the manner mentioned above, an air flow B is injected from the air injection port 23.

In the present structure example, since the holes 26 are formed in the opposite side to the air flow injection port 23 as mentioned above, the compressed air is injected out from the holes 26 so as to move in the space 25 toward the air flow injection port 23 (refer to an arrow in FIG. 1B).

In the mean while, the compressed air moves in a direction of entire length of the air box 2, that is, a direction of a terminal end side, inside the space 25.

The pressure of the compressed air is regulated inside the air box in the manner mentioned above, whereby it is possible to make an injection amount and injection speed of the air flow B from all the air flow injection ports 23 in the air box 2 uniform and constant.

In this case, if necessary, the compressed air is appropriately injected into the air pipe 22 from an mounting pipe 34a in an opposite end to the mounting pipe 34.

The spray tube 1 is fitted and fixed to plurality of holders 4 attached to the outer wall 21 of the air box 2.

At this time, a position of the spray tube 1 is fixed to the air box 2, in such a manner that a nozzle port 11a of the spray nozzle 11 is directed to the air flow injection port 23 of the air box 2, that is, the liquid L sprayed from the nozzle port 11a gets on the air flow B injected from the air flow injection port 23, as shown in FIG. 1B.

In this case, in accordance with the liquid spray unit A1 in which each of the members is arranged as mentioned above, the air flow B is injected from the air flow injection port 23 to the liquid L sprayed from the nozzle port 11a of the spray nozzle 11.

In accordance with the operation mentioned above, the liquid L is accelerated by the air flow B having high flow speed, and is sprayed and applied to the surface of the traveling body with greater momentum.

In the paper making machine or the like, in order to avoid a defect in dry of the paper and an excess attaching of medical agent, an amount of the liquid (an antipollution agent, a mold releasing agent or the like) sprayed to the traveling body is normally restricted to a small amount.

Accordingly, the spray nozzle 11 frequently employs the binary fluid nozzle which is suitable for low volume spray and can be easily regulated at a spray amount.

However, the liquid sprayed by the binary fluid nozzle generally has weak impact (momentum) at a time when the fluid reaches the traveling body in comparison with the case of a single fluid nozzle suitable for a large amount of spray, and is easily rolled up to a downstream side by a surface current of the traveling body.

In accordance with the liquid spray-unit A1 of the present invention, it is possible to accelerate the spray liquid L originally having only the weak impact (small momentum) by the air flow B so as to apply great impact (an accerlerating effect).

Accordingly, even in the case that the nozzle which can not be conventionally used in the very high speed paper making machine or the like due to the too weak impact is used in the liquid spray unit in accordance with the present invention, the liquid can securely reach the traveling body without being rolled up.

Further, in the case of spraying the liquid by the spray nozzle, there is a case that the liquid mist soars in the periphery of the spray pattern.

However, if the liquid spray unit A1 in accordance with the present invention is used, it is possible to prevent the mist from soaring.

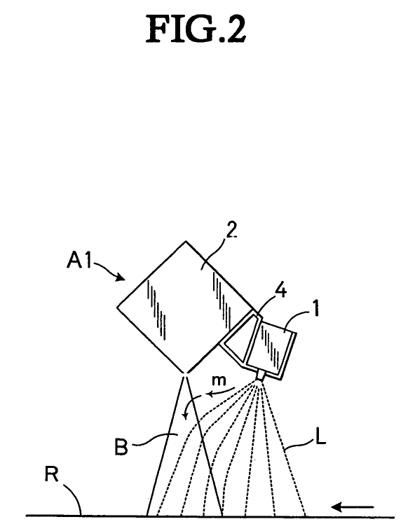

FIG. 2 is a schematic view showing a state in which the liquid spray unit A1 prevents the mist from soaring.

As mentioned above, the air flow B effectively captures even the mist m which is going to break away from a spray pattern of the liquid L sprayed from the spray nozzle so as to roll up, and accelerates the mist m so as to spray onto the surface of the traveling body R.

Accordingly, it is possible to approximately completely inhibit the liquid L (including the liquid mist m) from being rolled up, and it is possible to effectively apply approximately all the amount of the liquid L to the traveling body R.

In this connection, the description is mainly given of the case that the spray nozzle 11 is constituted by the binary fluid nozzle, however, it is of course possible to use the single fluid nozzle as the spray nozzle 11. In this case, the same accelerating effect as the case of the binary fluid nozzle mentioned above can be achieved.

Further, it is not necessary that the spray nozzle 11 has a special specification, and the spray nozzle 11 may be appropriately selected from the normal single fluid nozzle and the binary fluid nozzle while taking the applying amount of the liquid into consideration.

It goes without saying that the structure of the spray tube 1 can be appropriately changed in correspondence to the kind and the sturcture of the spray nozzle 11 as occasion demands.

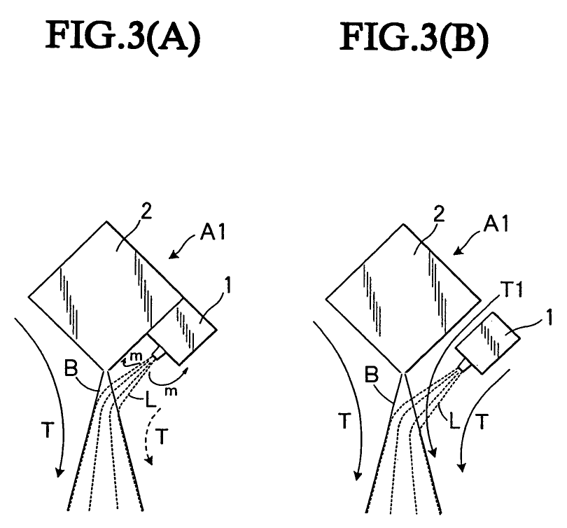

In this case, in the liquid spray unit A1 in accordance with the present invention, if the spray tube 1 and the air box 2 are fixed in a closely attached state, there is a case that the spray tube 1, the air box 2 and the like are contaminated by the liquid L (refer to FIG. 3(A)).

It can be considered that this matter is generated because both the elements are closely attached and fixed, whereby an accompanying air flow T of the air flow B becomes turbulent and weak in the spray tube side (refer to a dotted arrow T in FIG. 3A), and a part of the mist m comes to the spray tube 1 and the air box 2.

On the other hand, in the case that the spray tube 1 and the air box 2 are fixed at a certain interval as shown in FIG. 3(B), the accompanying air flow T1 can flow between both the elements, so that it is possible to inhibit the mist m from being attached.

In accordance with experiments, it has been known that the accompanying air flow T1 can flow effectively by setting the interval between both the elements to 2 mm or more, and it is possible to effectively inhibit the mist m from being attached.

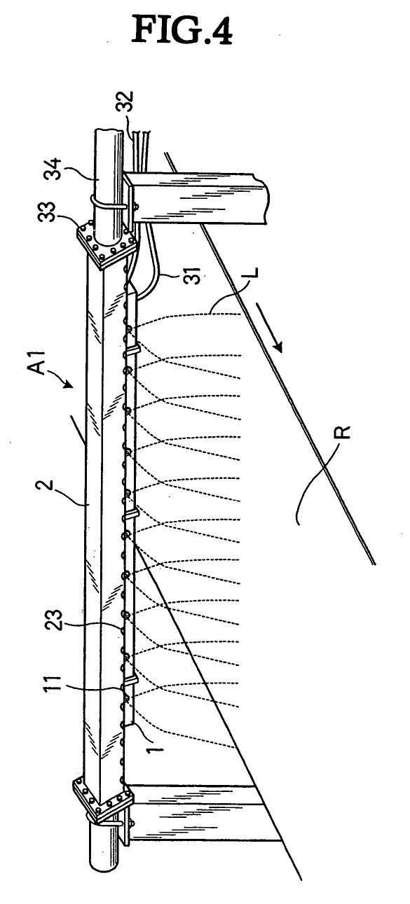

FIG. 4 shows a state in which the liquid is sprayed and applied to the paper by using the liquid spray unit A1 in accordance with the present structural example (the unit A is actually longer in most cases).

Since the liquid L is accelerated by the air flow injected from the air flow injection port 23 so as to change a forward moving direction, after being sprayed from the spray nozzle 11 of the spray tube 1, the liquid L is sprayed and applied to the traveling body R while drawing a locus which is shown to be bent in the middle.

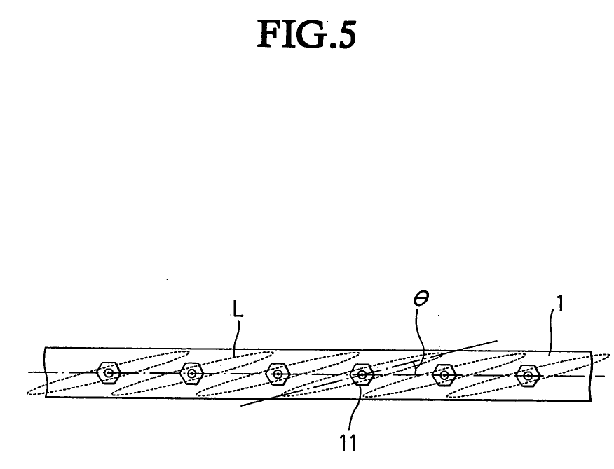

At this time, it is preferable that the spray nozzle 11 employs a nozzle in which a spray pattern is flat (fan shape), and is fixed in a state of being inclined to the spray tube 1 as shown in FIG. 5, such as to prevent the liquids L sprayed from the adjacent spray nozzles from being collided with each other.

In accordance with the experiments, in the case that a spray angle (θ in FIG. 5) of the liquid L with respect to a center in the longitudinal direction of the spray tube 1 is inclined at about 15° degree, it is known that it is possible to avoid the collision between the liquids L so as to uniformly spray and apply the liquid to the traveling body.

Just for reference, a characteristic of a liquid spray method for spraying and applying the liquid L to the traveling body R by using the liquid spray unit A1 exists in a point that the air flow is injected from the air injection port 23 to the liquid L sprayed from the spray nozzle 11, and the sprayed liquid L is accelerated by the air flow and sprayed to the traveling body R, as shown in FIG. 4.

As shown in the drawing, the spray tube 1 of the liquid spray unit A1 in accordance with the present structure example is provided with plurality of spray nozzles 11 which are arranged in parallel at a fixed interval in a width direction of the traveling body R (the paper in this example).

Accordingly, the unit A1 is suitable for a case that a comparatively large amount of liquid L (that is, chemical) is sprayed and applied to an entire surface of the traveling body R.

The liquid spray method mentioned above can be used in the case of spraying and applying the antipollution agent, the mold releasing agent, the cleaning agent or the like to the canvas, the press roll, the wire, the felt or the like, as mentioned above.

Even in the case that the mold releasing agent, the adhesive agent or the like is sprayed and applied to the Yankee drier, the function can be effectively achieved.

Further, it is of course possible to spray the pitch control agent to the wire, the felt, the press roll or the like.

In accordance with the present invention, it is possible to effectively spray and apply the chemical to the paper traveling at high speed.

For example, it is possible to directly spray and apply the pitch control agent mentioned above to the paper.

Further, it is possible to effectively spray and apply the chemical such as a paper strength increasing agent, a size agent, a yield improving agent or the like to the paper by a wire part, a press part or the like of the paper making machine.

It is suitable for spraying and applying an interlayer adhesive agent to the paper moving inside the paper making machine for making paper such as multi-layer boardpaper or the like.

On the other hand, it is possible to spray a wax lubricant to the roll, for example, in a corrugating machine so as to apply to corrugating medium base paper via the roll, in addition to the paper making machine, or it is possible to apply a water repellent agent, an oil repellent agent, a slide preventing agent, an antistatic agent or the like to a liner via the roll or the like.

Further, the present invention can be used even in the case that a softening agent, a moistening agent, anti-fungus agent, an aroma chemical, a dye stuff, pigment, moisture content, or the like to the paper in the paper processing machine or a humidifier.

Further, the liquid spray unit can effectively achieve the function even in the case that the liquid such as the medical agent or the like is sprayed to a half-finished product traveling inside a manufacturing unit for various products such as a semiconductor manufacturing unit or the like, the case that a paint is sprayed to a traveling subject, or the like.

### Second Embodiment

As mentioned above, the speed of the paper making machine or the like becomes higher and higher in recent years, however, there is a tendency that the entire unit becomes compact and the interval between the members and the paper becomes narrow.

Accordingly, there is a case that it is necessary to make the liquid spray unit more compact.

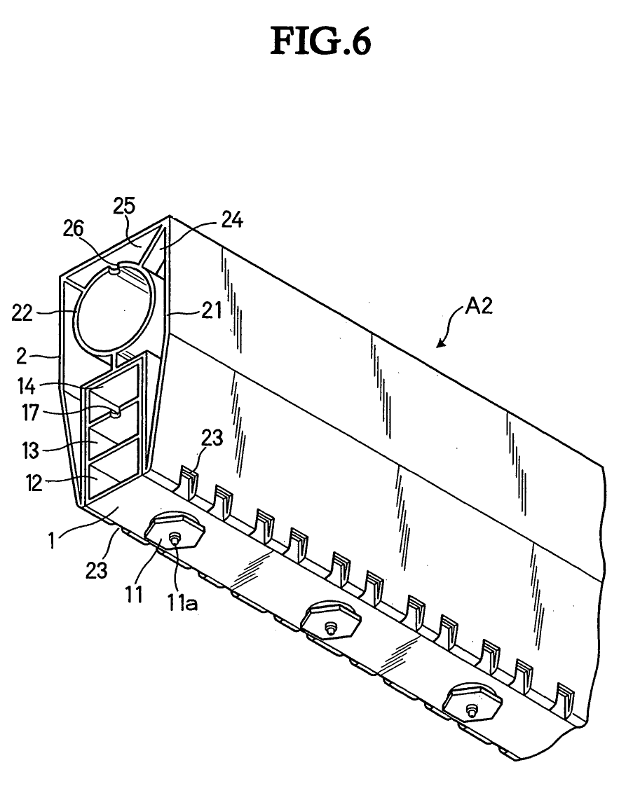

FIG. 6 is a cross sectional perspective view showing a liquid spray unit which is made more compact.

The liquid spray unit A2 is formed as compact structure by employing structure obtained by fitting and fixing the spray tube 1 to the air box 2.

The spray tube 1 has the same structure as the spray tube 1 of the unit A1 mentioned above, and is designed such as to employ the structure used in the unit A1 as it is.

The air box 2 is provided, in the same manner as the unit A1, an outer wall 21 and an air pipe 22 in an inner portion thereof. The air pipe 22 is fixed to an inner wall of the outer wall 21 via a support piece 24, and space 25 is continuously formed between the outer wall 21 and the air pipe 22.

Further, plurality of through holes 26 are formed at opposite positions to an air flow injection port 23 in a tube wall of the air pipe 22.

In the present structural example, the structure is made such that the outer wall 21 is folded back for the purpose of fitting the spray tube 1, however, the air flow injection port 23 is formed by notching a portion near the fold back portion.

Accordingly, two rows of air flow injection ports 23 are formed in parallel so as to pinch front and rear sides of the spray nozzle 11.

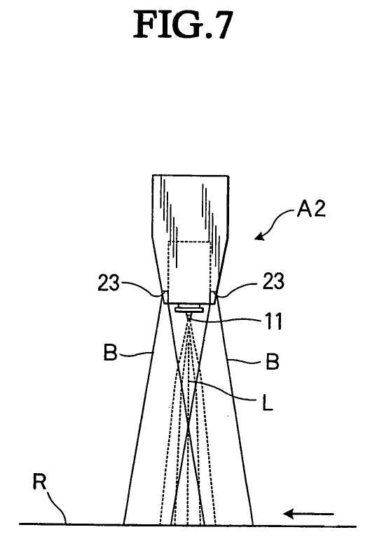

FIG. 7 is a schematic view showing a state in which the liquid and the air flow are injected from the liquid spray unit A2.

As mentioned above, the liquid L sprayed from the spray nozzle 11 of the unit A2 gets on two air flows B injected from the air flow injection port 23, and is accelerated so as to be securely sprayed and applied to the traveling body R.

In this connection, the air flow injection port 23 may be of course formed only in one side of the spray nozzle 11 in place of both sides thereof, or the structure may be appropriately made such that the air flow injection port 23 may be formed in both sides of the injection nozzle 11 and only one side is used while the other side is closed as occasion demands.

### Third Embodiment

The paper just after being conveyed to the dry part of the paper making machine contains a comparatively large amount of moisture content, and a gum pitch, talc, a micro fiber or the like tends to be transferred from the paper to the drier roll.

Accordingly, in the case of spraying the antipollution agent, the mold releasing agent or the like containing the wax or the like to the drier roll, if it is sprayed too much, there is a case that the paper is adversely affected inversely.

As mentioned above, a small amount (micro amount) of liquid spray is frequently requested in the liquid application to the paper making machine or the like.

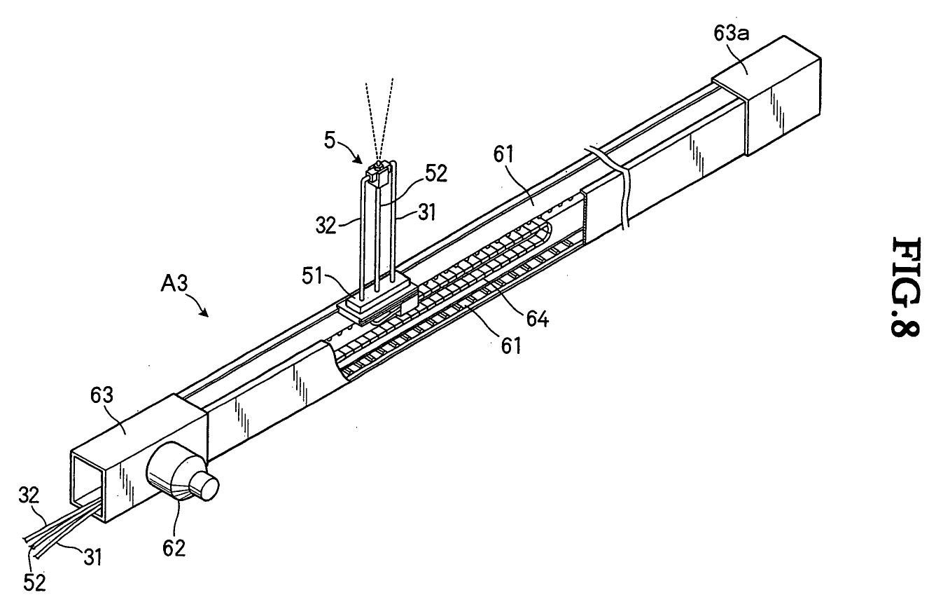

FIG. 8 is a perspective view showing a liquid spray unit A3 which is suitable for the small amount of liquid spray mentioned above.

The liquid spray unit A3 is structured such that the head portion 5 including the spray tube 1 sprays the liquid while reciprocating in the width direction of the traveling body, and sprays and applies the liquid to the traveling body.

A description will be given first of the head portion 5 of the liquid spray unit A3.

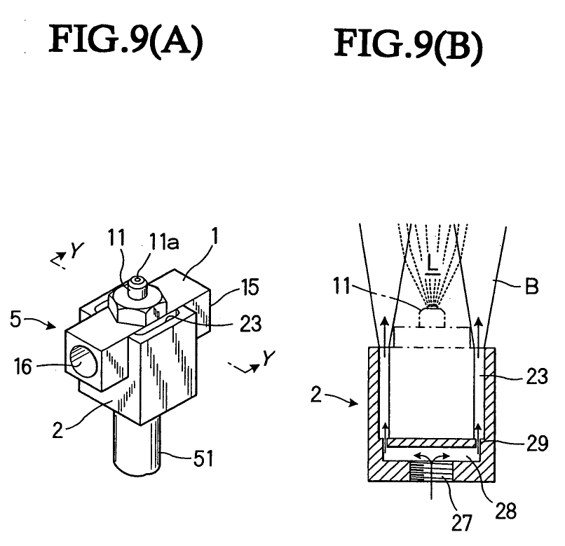

FIGS. 9(A) and 9(B) are views enlarging the head portion of the liquid spray unit, in which FIG. 9(A) is a perspective view of the entire head portion, and FIG. 9(B) is a cross sectional view along a line Y-Y of the air box 2 (an arrow in the figure shows a flow of the compressed air).

The head portion 5 is constituted by the spray tube 1 and the air box 2 in the same manner as mentioned above, however, the spray tube 1 is different in a point that the spray tube 1 is provided with only one spray nozzle 11.

In the present structural example, since the spray nozzle 11 employs the binary fluid nozzle suitable for the small amount of liquid spray, the spray tube 1 is provided with a liquid injection port 15 and an air injection port 16.

The spray tube 1 is fitted and fixed to the air box 2.

The compressed air is injected to the air box 2 via an air injection port 27, and the compressed air fills in space 28 and is injected from the air flow injection port 23 through a hole 29.

In the same manner as the case of the unit A2 shown in FIG. 7, the liquid L sprayed from the spray nozzle 11 gets on two air flows B injected from the air flow injection port 23, and is accelerated so as to be securely sprayed and applied to the traveling body. This matter can be easily understood from FIG. 8(B).

Next, a description will be given of the liquid spray unit A3 provided with the head portion 5 mentioned above.

As shown in FIG. 8, the liquid spray unit A3 is constituted by a moving belt 61, a drive motor 62 or the like in addition to the head portion 5 mentioned above.

The moving belt 61 is provided in a tensional manner between a roller rotated by the drive motor 62 and an opposite end roller (both not being illustrated), and reciprocates between two box portions 63 and 63a.

A base portion 51 of the head portion 5 is fixed to the moving belt 6, moves in correspondence to a reciprocating movement of the moving belt 6, and reciprocates the head portion 5 in a longitudinal direction of the liquid spray unit A3.

An air supply tube 52, a liquid supply tube 31 and a gas supply tube 32 are provided so as to stand up from the base portion 51, and are respectively connected to an air injection port 27, a liquid injection port 15 and a gas injection port 16 of the head portion 5 (refer to FIG. 9).

The air supply tube 52, the liquid supply tube 31 and the gas supply tube 32 are bundled in a lower side of the base portion 51, are inserted through a cable bear 64 and are connected to a chemical tank, a compressor or the like (not shown) in an external portion of the unit.

The air supply tube 52 and the like supply the liquid and the gas (air) to the head portion 5 while being protected by the cable bear 64 which flexibly changes a shape thereof in correspondence to motions of the head portion 51, even if the head portion 51 moves in correspondence to a reciprocating movement of the moving belt 61.

In this case, a description will be given below of a liquid spray method for spraying and applying the liquid to the traveling body by using the liquid spray unit A3, on the basis of an example of a case that a micro amount of antipollution agent is applied, mold releasing agent or the like containing the wax to the drier roll of the paper making machine.

A strong surface current is generated near the surface of the drier roll on the basis of the very high speed of the paper making machine, however, in accordance with the liquid spray unit A3, it is possible to securely apply a micro amount of chemical (for example, spray emulsion which quality is 10 w/% of solid body of the wax at about 5 cc/min).

The liquid spray unit A3 is placed in the width direction of the drier roll in the same manner as the case of the unit A1 mentioned above (refer to FIG. 4).

Further, the head portion 5 sprays the chemical to the drier roll while reciprocating at speed of about 2 m/min between two box portions 63 and 63a of the unit, and injects a strong air flow from the air flow injection port 23 so as to accelerate the chemical and spray to the drier roll.

The drier roll is generally heated to about 80 to 100° C., and when the chemical is applied to the surface of the drier roll, the moisture in the chemical is evaporated, the wax is liquefied so as to make viscosity small and be diffused on the surface, and a significantly thin oil film is formed.

The wax is transferred to the paper little by little so as to be consumed, however, since the chemical is appropriately supplied from the head portion 5, an antipollution effect, a mold releasing effect or the like can be maintained.

The liquid spray method using the liquid spray unit A3 is not limited to the spray and application of the antipollution agent (also called as a dusting preventing agent), the mold releasing agent or the like to the drier roll as mentioned above.

For example, in the case of applying the antipollution agent or the mold releasing agent to the canvas, it is possible to once spray and apply to a canvas roll (an out roll) by using the unit A3 so as to apply the antipollution agent or the like to the canvas via the roll.

In addition, it goes without saying that it is possible to effectively apply a micro amount of chemical to the member such as the paper making machine, the processing machine or the like, or the paper moving in the paper making machine or the processing machine, by using the unit A3.

For example, there is a case that an extremely micro amount of surface modifying agent containing a solid lubricant (for example, the chemical containing 1% as solid weight % of melamine cyanurate (MCA) at about 2 cc/min) is applied to the Yankee drier, however, the medical agent (the chemical) is hardly rolled up even by the micro amount application mentioned above, so that it is possible to effectively spray and apply.

The description is given above of the present invention, however, it goes without saying that the present invention is not limited only to the present embodiment, but can employ various modified examples.

For example, it is of course possible to use the head portion 5 of the liquid spray unit A3 in a state in which the head portion 5 does not move, and a plurality of head portions 5 of the unit A3 may be provided in parallel so as to be used, in place of the provision of the unit A1.

Further, for example, it is of course possible to mix two or more kinds of chemicals so as to spray, such as the paper strength increasing agent and the size agent.

Further, the other spray tube and air box than those exemplified in the units A1, A2 and A3 can be employed as far as their functions can be achieved.

### INDUSTRIAL APPLICABILITY

The present invention relates to a liquid spray unit applied to an object traveling at high speed, and more particularly, to a liquid spray unit for securely applying liquid to the paper moving at high speed by a paper making machine or the like, rolls such as a drier roll, a press roll and the like in the paper making machine or the like, and members such as a canvas, wire or the like, however, can be applied to the other liquid spray unit in the other fields than the paper making technique, and the same effect can be expected as long as deviates from the principle.

1. A liquid spray unit for spraying and applying liquid to a traveling body, comprising:
a spray nozzle for spraying the liquid; and
an air flow injecting port for injecting an air flow,
wherein the spray nozzle and the air flow injecting port are arranged such as to inject the air flow to the liquid sprayed from said spray nozzle, from said air injecting port, and accelerate the sprayed liquid by said air flow so as to spray to the traveling body.

2. A liquid spray unit for spraying and applying liquid to a traveling body, comprising:
a spray tube provided with a spray nozzle for spraying the liquid; and
an air box provided with an air flow injecting port for injecting an air flow,
wherein the spray tube and the air box are arranged such as to inject the air flow to the liquid sprayed from said spray nozzle, from said air injecting port, and accelerate the sprayed liquid by said air flow so as to spray to the traveling body.

3. A liquid spray unit as claimed in claim 2, wherein said air box is provided with an outer wall and an air pipe mounted inside said outer wall via a support piece.

4. A liquid spray unit as claimed in claim 3, wherein said air pipe is structured such that plurality of through holes are formed at opposite positions to the air flow injecting port provided in the outer wall in the tube wall.

5. A liquid spray unit as claimed in claim 2, wherein said spray tube is provided with plurality of spray nozzles which are arranged in parallel at a fixed interval in a width direction of the traveling body.

6. A liquid spray unit as claimed in claim 5, wherein said spray tube is provided with a liquid feeding tube for feeding the liquid to the spray nozzle, an air feeding tube for feeding compressed air, and a pressure regulating tube for uniformizing pressure of the compressed air inside said air feeding tube.

7. A liquid spray unit as claimed in claim 6, wherein said spray tube is provided with a pressure regulating tube for uniformizing pressure of the liquid inside the liquid feeding tube.

8. A liquid spray unit as claimed in claim 2, wherein said spray tube is fixed to the air box at an interval.

9. A liquid spray unit as claimed in claim 5, wherein said spray nozzle has a flat spray pattern and is fixed to the spray tube in a state of being inclined with each other.

10. A liquid spray unit as claimed in claim 2, wherein said spray tube is fixed by being fitted to the air box.

11. A liquid spray unit as claimed in claim 2, wherein said spray tube is provided with one spray nozzle, and sprays and applies the liquid while reciprocating in a width direction of the traveling body.

12. A liquid spray unit as claimed in claim 1, wherein said traveling body is constituted by the paper moving in a paper making machine or a processing machine.

13. A liquid spray unit as claimed in claim 1, wherein said traveling body is constituted by a member rotating or circulating inside a paper making machine or a processing machine.

14. A liquid spray method of spraying and applying liquid to a traveling body by using the liquid spray unit as claimed in claim 1.

15. A chemical used for the liquid spray method as claimed in claim 14.

16. A chemical as claimed in claim 15, wherein said chemical is constituted by a combination of one or two of an antipollution agent, a dusting preventing agent, a pitch control agent, a mold releasing agent, an adhesive agent, a surface correcting agent, a cleaning agent, a paper strength intensifying agent, a size agent, a yield improving agent, a water repellent agent, an oil repellent agent, a slide preventing agent, a lubricant, a softening agent and a moistening agent.
